(19) United States
(12) Patent Application Publication
(10) Pub. No.: US 2024/0112364 A1
(43) Pub. Date: Apr. 4, 2024

(54) PERSON STATE DETECTION APPARATUS, PERSON STATE DETECTION METHOD, AND NON-TRANSITORY COMPUTER READABLE MEDIUM STORING PROGRAM

(71) Applicant: NEC Corporation, Minato-ku, Tokyo (JP)

(72) Inventor: Noboru YOSHIDA, Tokyo (JP)

(73) Assignee: NEC Corporation, Minato-ku, Tokyo (JP)

(21) Appl. No.: 17/769,103

(22) PCT Filed: Nov. 11, 2019
(86) PCT No.: PCT/JP2019/044139

§ 371 Date: Apr. 14, 2022

(51) Int. Cl. G06T 7/73; G06T 7/11; G06T 7/62; G06V 10/25

(52) U.S. Cl. CPC G06T 7/73; G06T 7/11; G06T 7/62; G06V 10/25; G06T 2207/20044; G06V 2201/07

(57) ABSTRACT

A person state detection apparatus (10) according to the present disclosure includes a skeleton detection unit (11) for detecting a two-dimensional skeletal structure of a person based on a two-dimensional image acquired from a camera, an aggregation unit (12) for aggregating skeleton information based on the two-dimensional skeletal structure detected by the detection unit (11) for each predetermined area in the two-dimensional image, and a state detection unit (13) for detecting a state of a target person for each predetermined area in the two-dimensional image based on the skeleton information aggregated by the aggregation unit (12).

### TECHNICAL FIELD

The present disclosure relates to a person state detection apparatus, a person state detection method, and a non-transitory computer readable medium storing a program.

### BACKGROUND ART

Recently, a technique in which a state of a person such as a posture and an action of the person is detected from an image captured by a monitoring camera has been used in a monitoring system and the like. As a technique related to detection of a posture of a person, Patent Literature 1 to 3 is known. Patent Literature 1 discloses a technique for recognizing a posture of a person from a temporal change of an image area of the person. Patent Literature 2 and 3 describes a technique for detecting a posture of a person by comparing previously stored posture information with estimated posture information in an image. In addition, Non Patent Literature 1 is known as a technique related to skeleton estimation of a person.

### CITATION LIST

### Patent Literature

Patent Literature 1: Japanese Unexamined Patent Application Publication No. 2010-237873
Patent Literature 2: Japanese Unexamined Patent Application Publication No. 2017-199303
Patent Literature 3: International Patent Publication No. WO2012/046392 Non Patent Literature
Non Patent Literature 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299

### SUMMARY OF INVENTION

### Technical Problem

As described above, in Patent Literature 1, since the posture of the person is detected based on a change of the image area of the person, it is essential that the person in the image stand upright. Thus, it is not possible to accurately detect the posture of the person depending on the posture of the person. Further, in Patent Literature 2 and 3, there is a possibility that detection accuracy may become poor depending on the area of the image. For these reasons, there is a problem in the related art that it is difficult to accurately detect the state of the person from a two-dimensional image obtained by capturing the person.

In view of such a problem, it is an object of the present disclosure to provide a person state detection apparatus, a person state detection method, person state detection, and a non-transitory computer readable medium storing a person state detection program capable of improving accuracy of detecting a state of a person.

### Solution to Problem

In an example aspect of the present disclosure, a person state detection apparatus includes: skeleton detection means for detecting a two-dimensional skeletal structure of a person based on an acquired two-dimensional image; aggregation means for aggregating skeleton information based on the detected two-dimensional skeletal structure for each predetermined area in the two-dimensional image; and state detection means for detecting a state of a target person for each predetermined area in the two-dimensional image based on the aggregated skeleton information.

In another example aspect of the present disclosure, a person state detection method includes: detecting a two-dimensional skeletal structure of a person based on an acquired two-dimensional image; aggregating skeleton information based on the detected two-dimensional skeletal structure for each predetermined area in the two-dimensional image; and detecting a state of a target person for each predetermined area in the two-dimensional image based on the aggregated skeleton information.

In another example aspect of the present disclosure, a non-transitory computer readable medium storing a person state detection program causes a computer to execute processing of: detecting a two-dimensional skeletal structure of a person based on an acquired two-dimensional image; aggregating skeleton information based on the detected two-dimensional skeletal structure for each predetermined area in the two-dimensional image; and detecting a state of a target person for each predetermined area in the two-dimensional image based on the aggregated skeleton information.

### Advantageous Effects of Invention

According to the present disclosure, it is possible to provide a person state detection apparatus, a person state detection method, person state detection, and a non-transitory computer readable medium storing a person state detection program capable of improving accuracy of detecting a state of a person.

### BRIEF DESCRIPTION OF DRAWINGS

FIG. 1 is a flowchart showing a monitoring method according to related art;

FIG. 2 is a block diagram showing an overview of a person state detection apparatus according to example embodiments;

FIG. 3 is a block diagram showing a configuration of a person state detection apparatus according to a first example embodiment;

FIG. 4 is a flowchart showing a person state detection method according to the first example embodiment;

FIG. 5 is a flowchart showing normal state setting processing of a person state detection method according to the first example embodiment;

FIG. 6 is a flowchart showing state detection processing of the person state detection method according to the first example embodiment;

FIG. 7 shows a human body model according to the first example embodiment;

FIG. 8 shows an example of detection of the skeletal structure according to the first example embodiment;

FIG. 9 shows an example of detection of the skeletal structure according to the first example embodiment;

FIG. 10 shows an example of detection of the skeletal structure according to the first example embodiment;

FIG. 11 shows an example of detection of a skeletal structure according to the first example embodiment;

FIG. 12 is a diagram for explaining an aggregation method according to the first example embodiment;

FIG. 13 is a diagram for explaining the aggregation method according to the first example embodiment; and

FIG. 14 is a block diagram showing an overview of hardware of a computer according to the example embodiments.

### DESCRIPTION OF EMBODIMENTS

Example embodiments will be described below with reference to the drawings. In each drawing, the same elements are denoted by the same reference signs, and the repeated description is omitted if necessary.

### (Study Leading to Example Embodiments)

Recently, image recognition technology utilizing machine learning has been applied to various systems. As an example, a monitoring system for performing monitoring using images captured by a monitoring camera will be discussed.

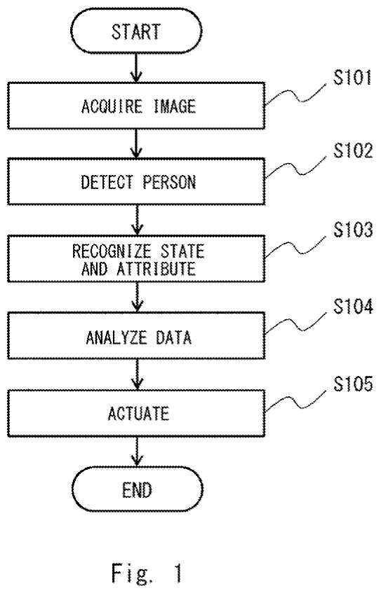

FIG. 1 shows a monitoring method performed by a monitoring system according to related art. As shown in FIG. 1, the monitoring system acquires an image from the monitoring camera (S101), detects a person from the acquired image (S102), and performs state recognition and attribute recognition of the person (S103). For example, a behavior (posture and an action) of the person are recognized as the states of the person, and age, gender, height, etc. of the person are recognized as the attributes of the person. Further, the monitoring system performs data analysis on the recognized states and attributes of the person (S104), and actuation such as processing based on an analysis result or the like is performed (S105). For example, the monitoring system displays an alert from the recognized behavior, etc., and the attribute such as the recognized height of the person is monitored.

As in the state recognition in this example, there is a growing demand particularly in a monitoring system for detecting the behavior of a person, which are different from usual behaviors, from videos captured by the monitoring camera. The behaviors include, for example, crouching down, lying down, and falling.

As a result of a study on a method for detecting a state such as a behavior of a person from an image, they found that it is difficult to easily detect the state by the related technique, and that it is not always possible to detect the state with high accuracy. With recent development of deep learning, it is possible to detect the behavior by collecting a large number of videos obtained by capturing a behavior and the like of an object to be detected and then learning them. However, it is difficult and costly to collect this learning data. Furthermore, for example, if a part of a person's body is hidden or a detection position is not considered, the state of the person may not be detected.

Therefore, the inventors studied a method using a skeleton estimation technique by means of machine learning for detecting a state of a person. For example, in a skeleton estimation technique according to related art such as OpenPose disclosed in Non Patent Literature 1, a skeleton of a person is estimated by learning various patterns of annotated image data. In the following example embodiments, a state of a person can be easily detected and an accuracy of the detection can be improved by utilizing such a skeleton estimation technique.

The skeletal structure estimated by the skeleton estimation technique such as OpenPose is composed of “key points” which are characteristic points such as joints, and “bones, i.e., bone links” indicating links between the key points. Therefore, in the following example embodiments, the skeletal structure is described using the terms “key point” and “bone”, but unless otherwise specified, the “key point” corresponds to the “joint” of a person, and a “bone” corresponds to the “bone” of the person.

### OVERVIEW OF EXAMPLE EMBODIMENTS

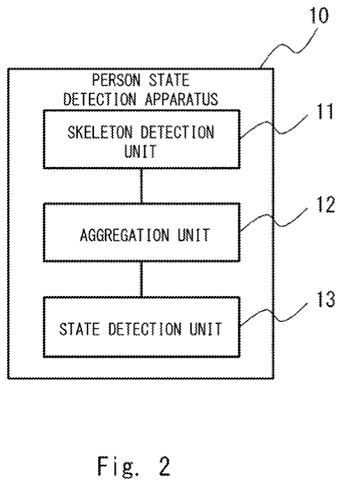

FIG. 2 shows an overview of a person state detection apparatus 10 according to the example embodiment. As shown in FIG. 2, the person state detection apparatus 10 includes a skeleton detection unit 11, an aggregation unit 12, and a state detection unit 13.

The skeleton detection unit 11 detects a two-dimensional skeletal structure of a person based on the two-dimensional image to be acquired. The aggregation unit 12 aggregates skeleton information based on the two-dimensional skeletal structure detected by the skeleton detection unit 11 for each predetermined area in the two-dimensional image. The state detection unit 13 detects a state of a target person for each predetermined area in the two-dimensional image based on the skeleton information aggregated by the aggregation unit 12.

Thus, in the example embodiments, a two-dimensional skeletal structure of a person is detected from a two-dimensional image, and skeleton information based on this two-dimensional skeletal structure is aggregated for each predetermined area, and a state of the person is detected based on the skeleton information for each predetermined area, which enables easy detection of the state of the target person, and accurate detection of the state of the person for each area.

### First Example Embodiment

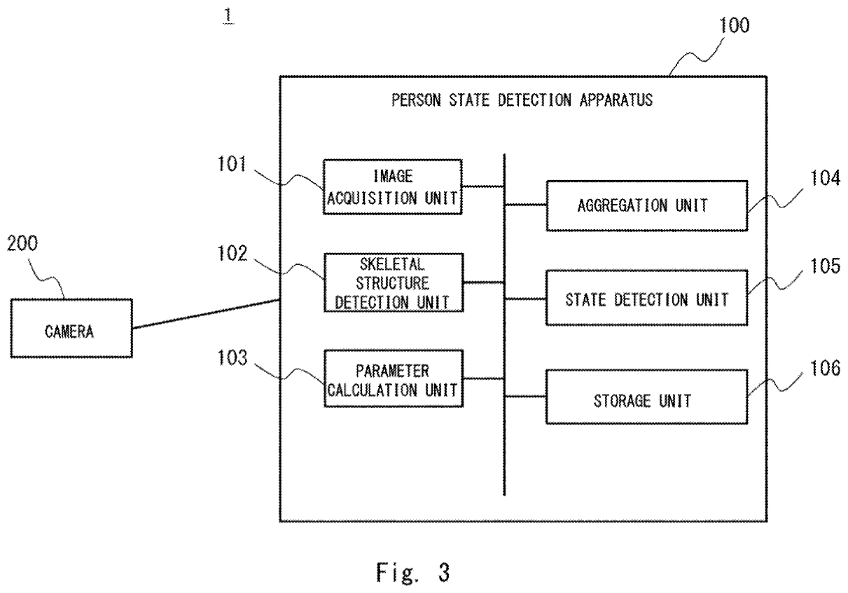

A first example embodiment will be described below with reference to the drawings. FIG. 3 shows a configuration of the person state detection apparatus 100 according to this example embodiment. The person state detection apparatus 100 and a camera 200 constitute a person state detection system 1. For example, the person state detection apparatus 100 and the person state detection system 1 are applied to a monitoring method in a monitoring system as shown in FIG. 1, and a state such as a behavior of a person is detected, an alarm corresponding to this detection is displayed, and other processing is performed. The camera 200 may be included inside the person state detection apparatus 100.

As shown in FIG. 3, the person state detection apparatus 100 includes an image acquisition unit 101, a skeletal structure detection unit 102, a parameter calculation unit 103, an aggregation unit 104, a state detection unit 105, and a storage unit 106. A configuration of each unit, i.e., each block, is an example, and may be composed of other units, as long as the method or an operation described later is possible. Further, the person state detection apparatus 100 is implemented by, for example, a computer apparatus such as a personal computer or a server for executing a program, and instead may be implemented by one apparatus or a plurality of apparatuses on a network.

The storage unit 106 stores information and data necessary for the operation and processing of the person state detection apparatus 100. For example, the storage unit 106 may be a non-volatile memory such as a flash memory or a hard disk apparatus. The storage unit 106 stores images acquired by the image acquisition unit 101, images processed by the skeletal structure detection unit 102, data for machine learning, data aggregated by the aggregation unit 104, and so on. The storage unit 106 may be an external storage apparatus or an external storage apparatus on the network. That is, the person state detection apparatus 100 may acquire necessary images, data for machine learning, and so on from the external storage apparatus or output data of the aggregation result and the like to the external storage apparatus.

The image acquisition unit 101 acquires a two-dimensional image captured by the camera 200 from the camera 200 which is connected to the camera calibration apparatus 100 in a communicable manner. The camera 200 is an imaging unit such as a monitoring camera installed at a predetermined position for capturing a person in an imaging area from the installed position. The image acquisition unit 101 acquires, for example, a plurality of images (videos) including a person captured by the camera 200, for example, in a predetermined aggregation period or at a predetermined detection timing.

The skeletal structure detection unit 102 detects a two-dimensional skeletal structure of the person in the image based on the acquired two-dimensional image. The skeletal structure detection unit 102 detects the skeletal structure of the person based on the characteristics such as joints of the person to be recognized using a skeleton estimation technique by means of machine learning. The skeletal structure detection unit 102 detects the skeletal structure of the person to be recognized in each of the plurality of images. The skeletal structure detection unit 102 uses, for example, the skeleton estimation technique such as OpenPose of Non Patent Literature 1.

The parameter calculation unit 103 calculates a skeleton parameter (skeleton information) of the person in the two-dimensional image based on the detected two-dimensional skeletal structure. The parameter calculation unit 103 calculates the skeleton parameter for each of a plurality of skeletal structures in the plurality of detected images. The skeleton parameter is a parameter indicating a feature of the skeletal structure of the person, and is a parameter serving as a criterion for evaluating the state of the person. The skeleton parameter include, for example, a size (referred to as a skeleton size) and a direction (referred to as a skeleton direction) of the skeletal structure of the person. Both the skeleton size and the skeleton direction may be used as the skeleton parameters, or either one of them may be used as the skeleton parameter. The skeleton parameter may be a skeleton size and a skeleton direction based on a whole skeletal structure of the person, or a skeleton size and a skeleton direction based on a part of the skeletal structure of the person. The skeleton parameter may be based on, for example, a foot part, a torso part, or a head part as a part of a skeletal structure.

The skeleton size is a two-dimensional size of an area (referred to as a skeleton area) including the skeletal structure in the two-dimensional image, and is, for example, a height of the skeleton area (referred to as a skeleton height) of the skeleton area in an up-down direction. For example, the parameter calculation unit 103 extracts the skeleton area in the image and calculates the height of the skeleton area in the up-down direction (pixel count). Either or both of the skeleton height and a width of the skeleton area in a left-right direction (referred to as a skeleton width) may be used as the skeleton size. An up-down direction component of a vector (such as a central axis) in the skeleton direction may be used as the skeleton height, and a left-right direction component of a vector in the skeleton direction may be used as the skeleton width. Note that the up-down direction is an up-down direction in the image, for example, a direction perpendicular to the ground (reference plane). The left-right direction is a left-right direction in the image, for example, a direction parallel to the ground (reference surface) in the image.

The skeleton direction (a direction from the feet to the head) is a two-dimensional slope of the skeletal structure in the two-dimensional image. The skeleton direction may be a direction corresponding to a bone included in the detected skeletal structure or a direction corresponding to the central axis of the skeletal structure. It can be said that the skeleton direction is a direction of a vector based on the skeletal structure. For example, the central axis of the skeletal structure can be obtained by performing a PCA (Principal Component Analysis) on the information about the detected skeletal structure.

The aggregation unit 104 aggregates the plurality of calculated skeleton parameters and sets an aggregated value as a skeleton parameter of a normal state. The aggregation unit 104 aggregates the plurality of skeleton parameters based on the plurality of skeletal structures of the plurality of images captured in the predetermined aggregation period. The aggregation unit 104 obtains, for example, an average value of the plurality of skeleton vectors in aggregation processing and defines the average value as the skeleton parameter of the normal state. That is, the aggregation unit 104 obtains an average value of the skeleton sizes and skeleton directions of whole skeletal structures or parts of the skeletal structures. Note that other statistical values, such as intermediate values of the plurality of skeleton parameters, may be obtained in addition to the average values of the skeleton parameters. The aggregation unit 104 stores the aggregated skeleton parameters of the normal state in the storage unit 106.

The state detection unit 105 detects the state of the person, who is a detection target, included in the image based on the aggregated skeleton parameters of the normal state. The state detection unit 105 compares the skeleton parameter of the normal state stored in the storage unit 106 with the skeleton parameter of the person, who is the detection target, and detects the state of the person based on a result of the comparison. The state detection unit 105 detects whether or not the person is in the normal state (regular state), that is, whether or not the person is in the normal state or an abnormal state, according to whether or not the skeleton size and the skeleton direction of the whole or a part of the skeletal structure of the person is close to the value of the normal state. The state of the person may be evaluated based on both the skeleton size and the skeleton direction or either the skeleton size or the skeleton direction. Note that a plurality of states may be further detected in addition to the normal state and the abnormal state. For example, aggregate data may be prepared for each of the plurality of states, and the aggregate data having values closest to those of the state of the person may be selected.

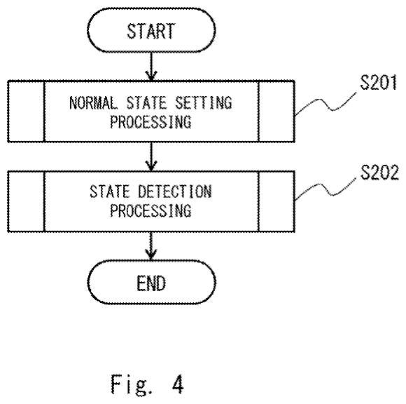

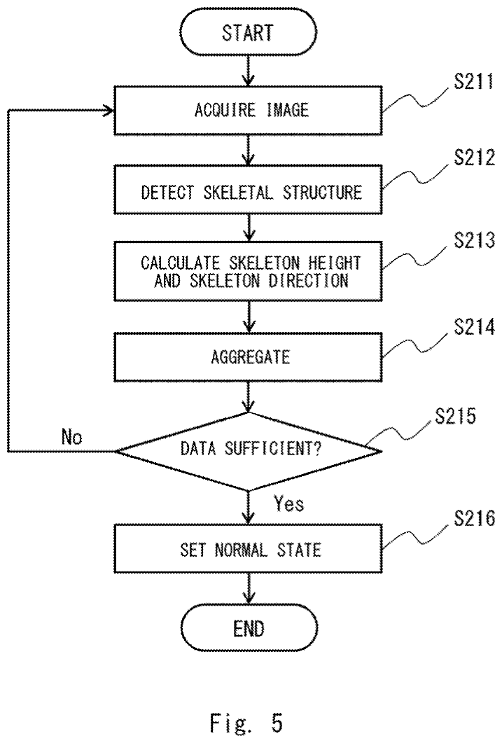

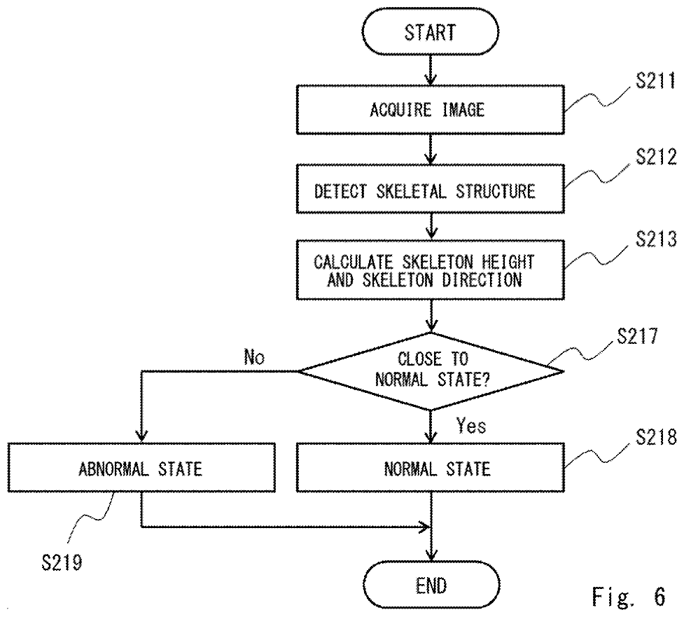

FIGS. 4 to 6 show operations (a person state detection method) of the person state detection apparatus 100 according to this example embodiment. FIG. 4 shows a flow of the entire operation of the person state detection apparatus 100. FIG. 5 shows a flow of normal state setting processing (S201) of FIG. 4. FIG. 6 shows a flow of state detection processing (S202) of FIG. 4.

As shown in FIG. 4, the person state detection apparatus 100 performs the normal state setting processing (S201), and then performs the state detection processing (S202). For example, the person state detection apparatus 100 sets the skeleton parameter of the normal state by performing the normal setting processing by using an image captured in the predetermined aggregation period (a period until necessary data is aggregated), and detects the state of the person, who is the detection target, by performing the state detection processing by using an image captured at a next detection timing (or in a detection period).

First, in the normal state setting processing (S201), the person state detection apparatus 100 acquires an image from the camera 200 as shown in FIG. 5 (S211). The image acquisition unit 101 acquires the image obtained by capturing a person for detecting a skeletal structure and setting the normal state.

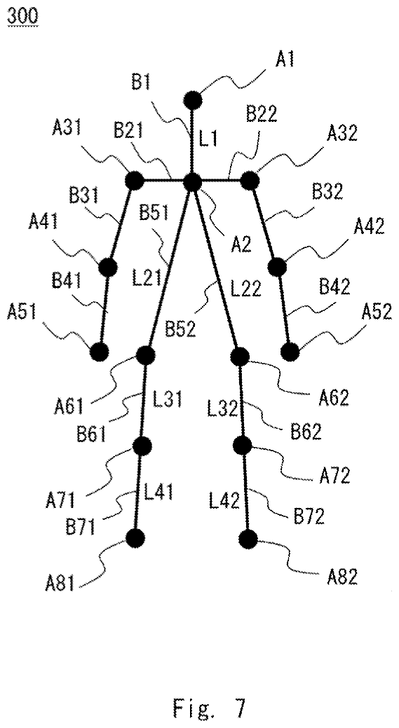

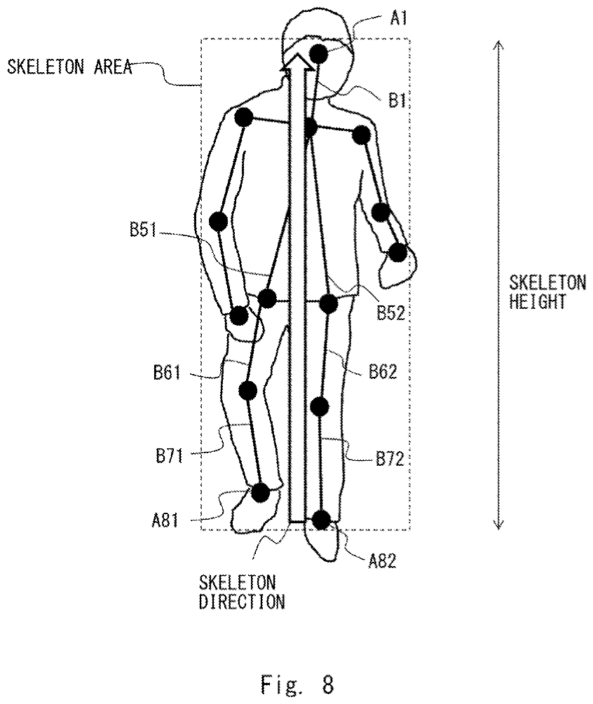

Next, the person state detection apparatus 100 detects the skeletal structure of the person based on the acquired image of the person (S212). FIG. 7 shows the skeletal structure of a human body model 300 detected at this time. FIGS. 8 to 11 show examples of detection of the skeletal structure. The skeletal structure detection unit 102 detects the skeletal structure of the human body model 300, which is a two-dimensional skeleton model, shown in FIG. 7 from the two-dimensional image by the skeleton estimation technique such as OpenPose. The human body model 300 is a two-dimensional model composed of key points such as joints of a person and bones connecting the key points.

The skeletal structure detection unit 102 extracts, for example, characteristic points that can be the key points from the image, and detects each key point of the person by referring to information obtained by machine learning the image of the key point. In the example of FIG. 7, as the key points of a person, a head A1, a neck A2, a right shoulder A31, a left shoulder A32, a right elbow A41, a left elbow A42, a right hand A51, a left hand A52, a right hip A61, a left hip A62, a right knee A71, a left knee A72, a right foot A81, and a left foot A82 are detected. Further, as the bones of the person connecting these key points, a bone B1 connecting the head A1 to the neck A2, bones B21 and B22 respectively connecting the neck A2 to the right shoulder A31 and the neck A2 to the left shoulder A32, bones B31 and B32 respectively connecting the right shoulder A31 to the right elbow A41 and the left shoulder A32 to the left elbow A42, bones B41 and B42 respectively connecting the right elbow A41 to the right hand A51 and the left elbow A42 to the left hand A52, bones B51 and B52 respectively connecting the neck A2 to the right hip A61 and the neck A2 to the left hip A62, bones B61 and B62 respectively connecting the right hip A61 to the right knee A71 and the left hip A62 to the left knee A72, bones B71 and B72 respectively connecting the right knee A71 to the right foot A81 and the left knee A72 to the left foot A82 are detected.

FIG. 8 shows an example in which a person standing upright is detected and the person standing upright is captured from the front. In FIG. 8, all the bones from the bone B1 of the head to the bone B71 and B72 of the legs as viewed from the front are detected. In this example, the head bone B1 is on the upper side of the image, and the leg bones B71 and B72 are on the lower side of the image. Since the bones B61 and B71 of the right leg are slightly bent than the bones B62 and B72 of the left leg, respectively, the bones B62 and B72 of the left leg are longer than the bones B61 and B71 of the right leg, respectively. That is, the bone B72 of the left leg extends farthest down among other bones.

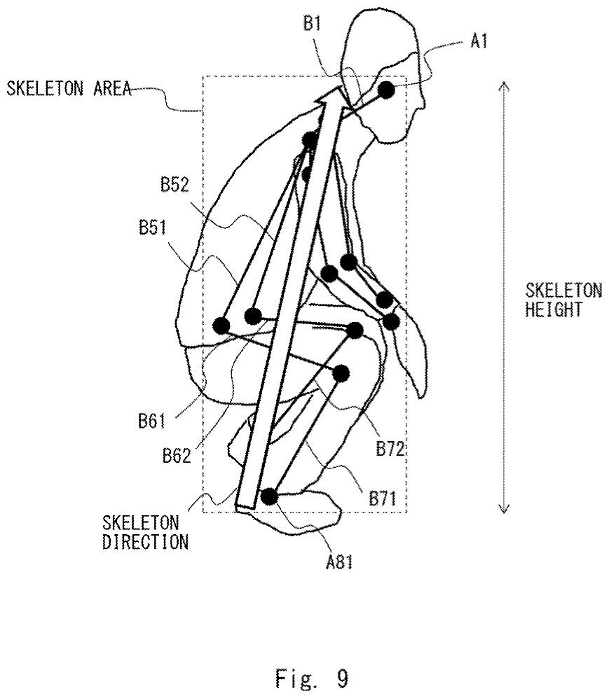

FIG. 9 shows an example of detection of a person in a crouching down state, and the person crouching down is captured from the right side. In FIG. 9, all the bones from the head bone B1 to the leg bones B71 and B72 as viewed from the right side are detected. In this example, the head bone B1 is on the upper side of the image, and the leg bones B71 and B72 are on the lower side of the image. Also, the bones B61 and B71 of the right leg and bones B62 and B72 of the left leg are largely bent and overlapped. Since the bones B61 and B71 of the right leg appear in front of the bones B62 and B72 of the left leg, the bones B61 and B71 of the right leg are longer than the bones B62 and B72 of the left leg, respectively. That is, the bone B71 of the right leg extends farthest down among other bones.

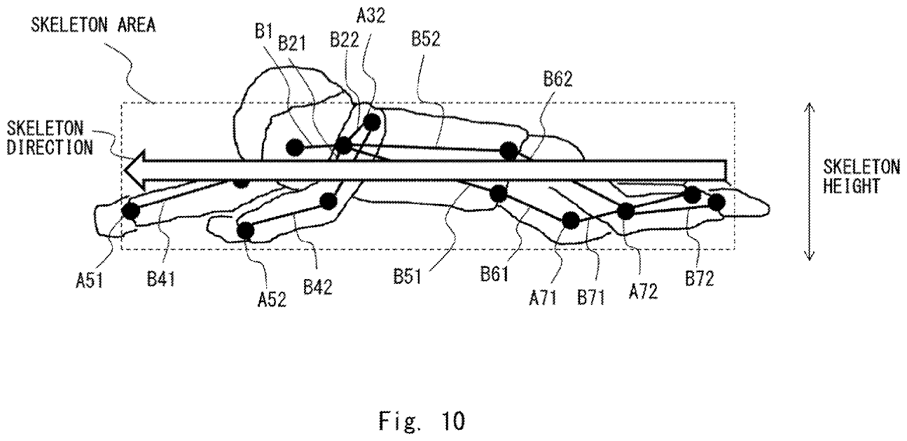

FIG. 10 shows an example of detection of a person in a lying down state, in which the person lying down with his/her both hands extended over the head and facing to the right is captured from diagonally forward on the left. In FIG. 10, all the bones from the bones B41 and B42 of the arms above the head to the bones B71 and B72 of the legs viewed from the left oblique front are detected. In this example, since the person is lying down in the left-right direction of the image, the bones B41 and B42 of the arms above the head are on the left side of the image, and the bones B71 and B72 of the legs are on the right side of the image. Further, the left side of the body (left shoulder bone B22, etc.) is on the upper side of the image, and the right side of the body (right shoulder bone B21, etc.) is on the lower side of the image. Also, the bone B42 of the left hand is bent and extends to the most front side, that is, extends farthest down among other bones.

Next, as shown in FIG. 5, the person state detection apparatus 100 calculates a skeleton height and a skeleton direction as the skeleton parameters of the detected skeletal structure (S213). For example, the parameter calculation unit 103 calculates the entire height (pixel count) of the skeletal structure in the image and calculates an overall direction (inclination) of the skeletal structure. The parameter calculation unit 103 obtains the skeleton height from the coordinates of end parts of the skeleton area to be extracted and the coordinates of the key points of the end parts, and obtains the skeleton direction from the average of the inclination of the central axis of the skeletal structure and the inclination of each bone.

In the example of FIG. 8, a skeleton area including all bones is extracted from the skeletal structure of a person standing upright. In this case, an upper end of the skeleton area is an upper end of the bone B1 of the head part, and a lower end of the skeleton area is a lower end of the bone B72 of the left leg. Therefore, the length in the up-down direction from the upper end of the bone B1 of the head part (key point A1) to the lower end of the bone B72 of the left leg (key point A82) is defined as the skeleton height. A middle point between the lower end of the bone B72 of the left leg (key point A82) and the lower end of the bone B71 of the right leg (key point A81) may be the lower end of the skeleton area. For example, when the information of all bones is subjected to a PCA analysis, a central axis extending in the up-down direction at the center of the skeleton area is obtained. The direction of this central axis, that is, the direction extending from the bottom (leg) to the top (head part) at the center of the skeleton area, is defined as the skeleton direction. For example, when the person is standing upright, the skeleton direction is substantially perpendicular to the ground.

In the example of FIG. 9, a skeleton area including all bones is extracted from the skeletal structure of a person crouching down. In this case, an upper end of the skeleton area is an upper end of the bone B1 of the head part, and a lower end of the skeleton area is the lower end of the bone B71 of the right leg. Therefore, the length in the up-down direction from the upper end of the bone B1 of the head part (key point A1) to the lower end of the bone B71 of the right leg (key point A81) is defined as the skeleton height. For example, when the information of all bones is subjected to a PCA analysis, a central axis extending from the lower left to the upper right of the skeleton area is obtained. The direction of this central axis, that is, the direction extending from the lower left (leg) to the upper right (head part) of the skeleton area, is defined as the skeleton direction. For example, if a person is crouching down (sitting), the skeleton direction is oblique to the ground.

In the example of FIG. 10, a skeleton area including all bones is extracted from the skeletal structure of a person lying down in the left-right direction of the image. In this case, an upper end of the skeleton area is an upper end of the bone B22 of the left shoulder, and a lower end of the skeleton area is the lower end of the bone B42 of the left arm. Therefore, the length in the up-down direction from the upper end of the bone B22 of the left shoulder (key point A32) to the lower end of the bone B42 of the left arm (key point A52) is defined as the skeleton height. A middle point between the lower end of the bone B42 of the left arm (key point A52) and the lower end of the bone B41 of the right arm (key point A51), or between the lower end of the bone B72 of the left leg (key point A72) and the lower end of the bone B71 of the right leg (key point A71) may be the lower end of the skeleton area. For example, when the information of all bones is subjected to a PCA analysis, a central axis extending in the left-right direction at the center of the skeleton area is obtained. The direction of this central axis, that is, the direction extending from the right (leg) to the left (head part) at the center of the skeleton area, is defined as the skeleton direction. For example, if a person is lying down, the skeleton direction is substantially parallel to the ground.

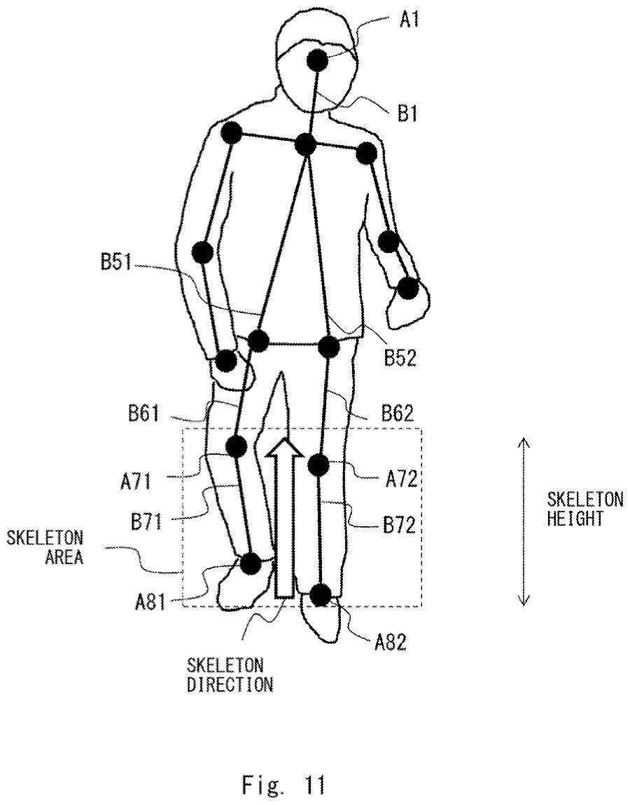

As shown in FIG. 11, a height of a part of the skeletal structure and a direction of a part of the skeletal structure may be obtained. In the example of FIG. 11, the skeleton height and the skeleton direction of the bones of the legs are shown as some of all the bones. For example, when the skeleton area of the bones B71 and B72 of the legs is extracted, the upper end of the skeleton area becomes the upper end of the right leg bone B71, and the lower end of the skeleton area becomes the lower end of the left leg bone B72. Therefore, the length in the up-down direction from the upper end of the bone B71 of the right leg (key point A71) to the lower end of the bone B72 of the left hand (key point A82) is defined as the skeleton height of the legs. A middle point between the upper end of the bone B71 of the right leg (key point A71) and the upper end of the bone B72 of the left leg (key point A72) may be the upper end of the skeleton area. A middle point between the lower end of the bone B72 of the left leg (key point A82) and the lower end of the bone B71 of the right leg (key point A81) may be the lower end of the skeleton area. For example, when the information of the bones B71 and B72 of the legs is subjected to a PCA analysis, a central axis extending in the up-down direction at the center of the skeleton area is obtained. The direction of this central axis, that is, the direction extending from the bottom (feet) to the top (knees) at the center of the skeleton area, is defined as the skeleton direction of the legs.

Next, as shown in FIG. 5, the person state detection apparatus 100 aggregates the plurality of calculated skeleton heights and skeleton directions (skeleton parameters) (S214), repeats processing of acquiring the image and aggregating the skeleton heights and skeleton directions (S211 to S214) until sufficient data is obtained (S215), and sets the aggregated skeleton heights and skeleton directions as the normal state (S216).

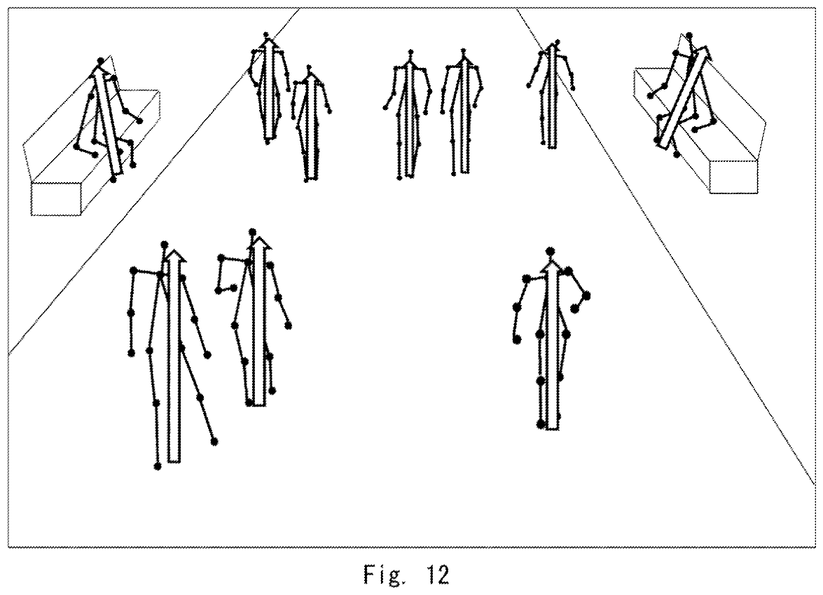

For example, as shown in FIG. 12, the aggregation unit 104 aggregates skeleton heights and skeleton directions from skeletal structures of persons detected at a plurality of positions in an image. In the example of FIG. 12, persons are passing through at the center of the image and some of them sit on benches at both ends of the image. When persons are walking, skeleton directions which are almost perpendicular to the ground and skeleton heights which are heights of the persons standing upright from feet to heads are detected, and the skeleton directions and the skeleton heights are aggregated. When persons are sitting, skeleton directions which are oblique with respect to the ground and skeleton heights which are heights of the sitting persons from feet to heads are detected, and the skeleton directions and the skeleton heights are aggregated.

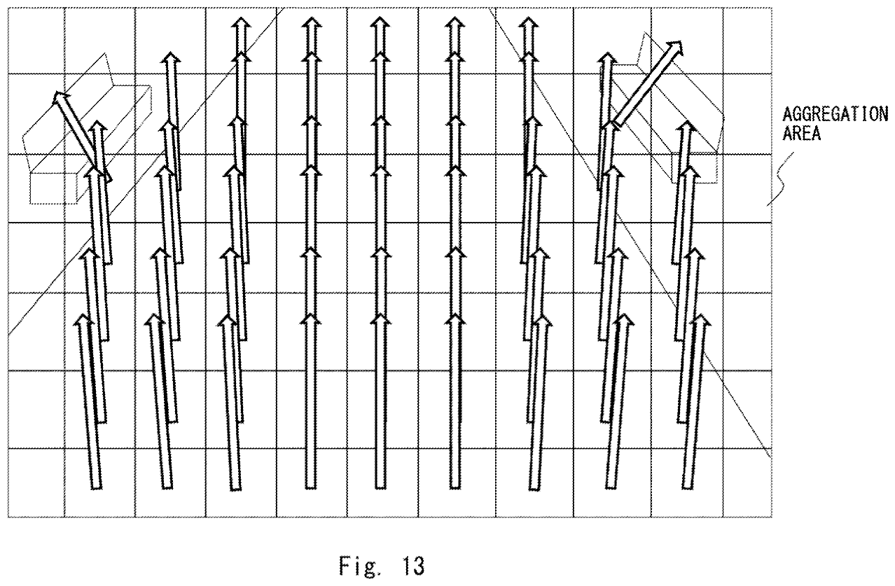

The aggregation unit 104 divides the image shown in FIG. 12 into a plurality of aggregation areas as shown in FIG. 13, aggregates the skeleton heights and the skeleton directions for each aggregation area, and sets a result of the aggregation for each aggregation area as the normal state. In the area where the persons walk, the skeleton direction approximately perpendicular to the ground becomes the normal state, and in the area where the persons sit, the skeleton direction oblique to the ground becomes the normal state.

For example, the aggregation area is a rectangular area obtained by dividing an image at predetermined intervals in the vertical and horizontal directions. The aggregation area is not limited to a rectangle and instead may be any shape. The aggregation area is divided at predetermined intervals without considering the background of the image. Note that the aggregation area may be divided in consideration of the background of the image, the amount of aggregated data, and the like. For example, the area (an upper side of the image), which is far from the camera, may be made smaller than the area (a lower side of the image), which is close to the camera, according to an imaging distance so as to correspond to the relationship between the image and the size of the real world. Further, an area having more skeleton heights and skeleton directions than those of another area may be made smaller than an area having fewer skeleton heights and skeleton directions according to the amount of data to be aggregated.

For example, skeleton heights and skeleton directions of persons whose feet (for example, lower ends of the feet) are detected in an aggregation area are aggregated for each aggregation area. When a part other than a foot is detected, the part other than the foot may be used as a reference for aggregation. For example, skeleton heights and skeleton directions of persons whose heads or torsos are detected in the aggregation area may be aggregated for each aggregation area.

An accuracy for setting the normal state and an accuracy for detecting a person can be improved by aggregating more skeleton heights and skeleton directions for each aggregation area. For example, it is preferable to aggregate three to five skeleton heights and skeleton directions for each aggregation area to obtain an average thereof. By obtaining the average of the plurality of skeleton heights and skeleton directions, data in the normal state in the aggregation area can be obtained. Although the calculation accuracy can be improved by increasing the number of the aggregation areas and the amount of the aggregated data, the calculation processing requires time and increases cost. By reducing the number of the aggregation areas and the amount of aggregated data, the calculation can be easily performed, but the detection accuracy may be reduced. Therefore, it is preferable to determine the number of the aggregation areas and the amount of aggregated data in consideration of the required detection accuracy and the cost.

Next, in the state detection processing (S202), as shown in FIG. 6, the person state detection apparatus 100 acquires an image obtained by capturing a person, who is a detection target (S211), detects a skeletal structure of the person, who is the detection target (S212), and calculates skeleton height and skeleton direction of the detected skeletal structure (S213) in a manner similar to FIG. 5.

Next, the person state detection apparatus 100 determines whether or not the calculated skeleton height and skeleton direction (skeleton parameters) of the person, who is the detection target, are close to the set skeleton height and skeleton direction of the normal state (S217), determines that the person, who is the detection target, is in the normal state when the calculated skeleton height and skeleton direction are close to those of the normal state (S218), and determines that the person, who is the detection target, is in the abnormal state when the calculated skeleton height and skeleton direction are far from those of the normal state (S219).

The state detection unit 105 compares the skeleton height and the skeleton direction of the normal state aggregated for each aggregation area with the skeleton height and the skeleton direction of the person, who is the detection target. For example, the state detection unit 105 recognizes an aggregation area including feet of the person, who is the detection target, and compares the skeleton height and the skeleton direction of the normal state in the recognized aggregation area with the skeleton height and the skeleton direction of the person, who is the detection target. When a difference between the skeleton height and the skeleton direction of the normal state and the skeleton height and the skeleton direction of the person, who is the detection target, or a ratio of the skeleton height and the skeleton direction of the normal state to those of the person, who is the detection target, is within a predetermined range (smaller than a threshold), it is determined that the person, who is the detection target, is in the normal state. When the above difference or ratio is outside the predetermined range (larger than a threshold), it is determined that the person, who is the detection target, is in the abnormal state. An abnormal state of a person may be detected when both the differences between the skeleton height and the skeleton direction of the normal state and those of the person, who is the detection target, are outside the predetermined range, or an abnormal state of a person may be detected when either one of these differences is outside the predetermined range. For example, the possibility (probability) in which the normal or abnormal state of the person may be obtained according to the differences between the skeleton height and the skeleton direction of the normal state and those of the person, who is the detection target.

For example, as shown in FIG. 8, it is assumed that the skeleton height and the skeleton direction of the person standing upright are set to the normal state. Then, as shown in FIG. 9, when the person is crouching down, the skeleton direction is close to that of the normal state, but the skeleton height is significantly different from the normal state. Thus, it is determined that the person is in the abnormal state. Further, as shown in FIG. 10, when the person is lying down, since the skeleton direction and the skeleton height are greatly different from those of the normal state, it is determined that the person is in the abnormal state.

As described above, in this example embodiment, the skeletal structure of the person is detected from the two-dimensional image, and the skeleton parameters such as the skeleton height and the skeleton direction obtained from the detected skeletal structure are aggregated and set to the normal state. Furthermore, by comparing the skeleton parameters of the normal state with those of the person, who is the detection target, the state of the person is detected. Thus, the state of the person can be easily detected, because only the ratio of the comparison of the skeleton parameters is required without using complicated calculation, complicated machine learning, camera parameters or the like. For example, by detecting the skeletal structure using the skeleton estimation technique, a state of a person can be detected without collecting learning data. Further, since information about the skeletal structure of the person is used, the state of the person can be detected regardless of the posture of the person.

Further, since the normal state can be automatically set for each place (scene) to be captured, the state of the person can be appropriately detected according to the place. For example, when a nursery school is being captured, the skeleton height of a person in a normal state is set low, so that a tall person can be detected as abnormal. Further, since the normal state can be set for each area of the image to be captured, the state of the person can be appropriately detected according to the area. For example, when the image includes a bench, the skeleton direction is inclined and the skeleton height is set low, because a person is sitting in the area of the bench in the normal state. In this case, a person standing or lying down in the area of the bench can be detected as abnormal.

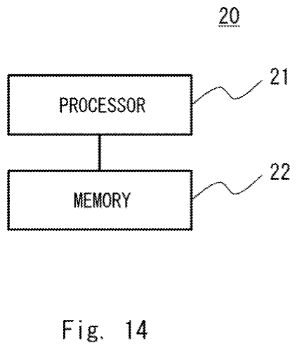

Note that each of the configurations in the above-described example embodiments is constituted by hardware and/or software, and may be constituted by one piece of hardware or software, or may be constituted by a plurality of pieces of hardware or software. The functions and processing of the person state detection apparatuses 10 and 100 may be implemented by a computer 20 including a processor 21 such as a Central Processing Unit (CPU) and a memory 22 which is a storage device, as shown in FIG. 14. For example, a program, i.e., a person state detection program, for performing the method according to the example embodiments may be stored in the memory 22, and each function may be implemented by the processor 21 executing the program stored in the memory 22.

These programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Further, the present disclosure is not limited to the above-described example embodiments and may be modified as appropriate without departing from the purpose thereof. For example, although a state of a person is detected in the above description, a state of an animal other than a person having a skeletal structure such as mammals, reptiles, birds, amphibians, fish, etc. may be detected.

Although the present disclosure has been described above with reference to the example embodiments, the present disclosure is not limited to the example embodiments described above. The configurations and details of the present disclosure may be modified in various ways that would be understood by those skilled in the art within the scope of the present disclosure.

The whole or part of the example embodiments disclosed above can be described as, but not limited to, the following supplementary notes.

### (Supplementary Note 1)

A person state detection apparatus comprising:
skeleton detection means for detecting a two-dimensional skeletal structure of a person based on an acquired two-dimensional image;
aggregation means for aggregating skeleton information based on the detected two-dimensional skeletal structure for each predetermined area in the two-dimensional image; and
state detection means for detecting a state of a target person for each predetermined area in the two-dimensional image based on the aggregated skeleton information.

### (Supplementary Note 2)

The person state detection apparatus according to Supplementary note 1, wherein
the skeleton information includes a size or a direction of the two-dimensional skeletal structure.

### (Supplementary Note 3)

The person state detection apparatus according to Supplementary note 2, wherein
the skeleton information is a size or a direction based on the entire two-dimensional skeletal structure.

### (Supplementary Note 4)

The person state detection apparatus according to Supplementary note 2, wherein
the skeleton information is a size or a direction based on a part of the two-dimensional skeletal structure.

### (Supplementary Note 5)

The person state detection apparatus according to Supplementary note 4, wherein
the skeleton information is a size or a direction based on a foot part, a torso part, or a head part included in the two-dimensional skeletal structure.

### (Supplementary Note 6)

The person state detection apparatus according to any one of Supplementary notes 2 to 5, wherein
the size of the two-dimensional skeletal structure is a height or a width of an area including the two-dimensional skeletal structure in the two-dimensional image.

### (Supplementary Note 7)

The person state detection apparatus according to any one of Supplementary notes 2 to 6, wherein
the direction of the two-dimensional skeletal structure is a direction corresponding to a bone included in the two-dimensional skeletal structure or a direction corresponding to a central axis of the two-dimensional skeletal structure.

### (Supplementary Note 8)

The person state detection apparatus according to any one of Supplementary notes 1 to 7, wherein
the aggregation means obtains a statistical value of the skeleton information for each of the predetermined areas.

### (Supplementary Note 9)

The person state detection apparatus according to any one of Supplementary notes 1 to 8, wherein
the predetermined area is an area obtained by dividing the two-dimensional image at predetermined intervals.

### (Supplementary Note 10)

The person state detection apparatus according to any one of Supplementary notes 1 to 8, wherein
the predetermined area is an area obtained by dividing the two-dimensional image according to an imaging distance.

### (Supplementary Note 11)

The person state detection apparatus according to any one of Supplementary notes 1 to 8, wherein
the predetermined area is an area obtained by dividing the two-dimensional image according to an amount of the skeleton information to be aggregated.

### (Supplementary Note 12)

The person state detection apparatus according to any one of Supplementary notes 1 to 11, wherein
the state detection means detects a state of the target person based on a result of a comparison between the aggregated skeleton information and the skeleton information based on the two-dimensional skeletal structure of the target person.

### (Supplementary Note 13)

The person state detection apparatus according to Supplementary note 12, wherein
the state detection means detects whether or not the state of the target person is a normal state by using the aggregated skeleton information as the skeleton information in the normal state.

### (Supplementary Note 14)

A person state detection method comprising:
detecting a two-dimensional skeletal structure of a person based on an acquired two-dimensional image;
aggregating skeleton information based on the detected two-dimensional skeletal structure for each predetermined area in the two-dimensional image; and
detecting a state of a target person for each predetermined area in the two-dimensional image based on the aggregated skeleton information.

### (Supplementary Note 15)

The person state detection method according to Supplementary note 14, wherein
the skeleton information includes a size or a direction of the two-dimensional skeletal structure.

### (Supplementary Note 16)

A person state detection program for causing a computer to execute processing of:
detecting a two-dimensional skeletal structure of a person based on an acquired two-dimensional image;
aggregating skeleton information based on the detected two-dimensional skeletal structure for each predetermined area in the two-dimensional image; and
detecting a state of a target person for each predetermined area in the two-dimensional image based on the aggregated skeleton information.

### (Supplementary Note 17)

The person state detection program according to Supplementary note 16, wherein
the skeleton information includes a size or a direction of the two-dimensional skeletal structure.

### REFERENCE SIGNS LIST

1 PERSON STATE DETECTION SYSTEM
10 PERSON STATE DETECTION APPARATUS
11 SKELETON DETECTION UNIT
12 AGGREGATION UNIT
13 STATE DETECTION UNIT
20 COMPUTER
21 PROCESSOR
22 MEMORY
100 PERSON STATE DETECTION APPARATUS
101 IMAGE ACQUISITION UNIT
102 SKELETAL STRUCTURE DETECTION UNIT
103 PARAMETER CALCULATION UNIT
104 AGGREGATION UNIT
105 STATE DETECTION UNIT
106 STORAGE UNIT
200 CAMERA
300 HUMAN BODY MODEL

What is claimed is:

1. A person state detection apparatus comprising:
at least one memory storing instructions, and
at least one processor configured to execute the instructions stored in the at least one memory to;
detect a two-dimensional skeletal structure of a person based on an acquired two-dimensional image;
aggregate skeleton information based on the detected two-dimensional skeletal structure for each predetermined area in the two-dimensional image; and
detect a state of a target person for each predetermined area in the two-dimensional image based on the aggregated skeleton information.

2. The person state detection apparatus according to claim 1, wherein
the skeleton information includes a size or a direction of the two-dimensional skeletal structure.

3. The person state detection apparatus according to claim 2, wherein
the skeleton information is a size or a direction based on the entire two-dimensional skeletal structure.

4. The person state detection apparatus according to claim 2, wherein
the skeleton information is a size or a direction based on a part of the two-dimensional skeletal structure.

5. The person state detection apparatus according to claim 4, wherein
the skeleton information is a size or a direction based on a foot part, a torso part, or a head part included in the two-dimensional skeletal structure.

6. The person state detection apparatus according to claim 2, wherein
the size of the two-dimensional skeletal structure is a height or a width of an area including the two-dimensional skeletal structure in the two-dimensional image.

7. The person state detection apparatus according to claim 2, wherein
the direction of the two-dimensional skeletal structure is a direction corresponding to a bone included in the two-dimensional skeletal structure or a direction corresponding to a central axis of the two-dimensional skeletal structure.

8. The person state detection apparatus according to claim 1, wherein
the at least one processor is further configured to execute the instructions stored in the at least one memory to obtain a statistical value of the skeleton information for each of the predetermined areas.

9. The person state detection apparatus according to claim 1, wherein
the predetermined area is an area obtained by dividing the two-dimensional image at predetermined intervals.

10. The person state detection apparatus according to claim 1, wherein
the predetermined area is an area obtained by dividing the two-dimensional image according to an imaging distance.

11. The person state detection apparatus according to claim 1, wherein
the predetermined area is an area obtained by dividing the two-dimensional image according to an amount of the skeleton information to be aggregated.

12. The person state detection apparatus according to claim 1, wherein
the at least one processor is further configured to execute the instructions stored in the at least one memory to detect a state of the target person based on a result of a comparison between the aggregated skeleton information and the skeleton information based on the two-dimensional skeletal structure of the target person.

13. The person state detection apparatus according to claim 12, wherein
the at least one processor is further configured to execute the instructions stored in the at least one memory to detect whether or not the state of the target person is a normal state by using the aggregated skeleton information as the skeleton information in the normal state.

14. A person state detection method comprising:
detecting a two-dimensional skeletal structure of a person based on an acquired two-dimensional image;
aggregating skeleton information based on the detected two-dimensional skeletal structure for each predetermined area in the two-dimensional image; and
detecting a state of a target person for each predetermined area in the two-dimensional image based on the aggregated skeleton information.

15. The person state detection method according to claim 14, wherein
the skeleton information includes a size or a direction of the two-dimensional skeletal structure.

16. A non-transitory computer readable medium storing a person state detection program for causing a computer to execute processing of:
detecting a two-dimensional skeletal structure of a person based on an acquired two-dimensional image;
aggregating skeleton information based on the detected two-dimensional skeletal structure for each predetermined area in the two-dimensional image; and
detecting a state of a target person for each predetermined area in the two-dimensional image based on the aggregated skeleton information.

17. The non-transitory computer readable according to claim 16, wherein
the skeleton information includes a size or a direction of the two-dimensional skeletal structure.
